(19) United States
(12) Patent Application Publication
(10) Pub. No.: US 2023/0169607 A1
(43) Pub. Date: Jun. 1, 2023

(54) Systems and Methods for Constructing, Valuing, and Reselling Stakes in Legal Claims

(71) Applicant: Arbi, Inc., dba ArbiLex, Boston, MA (US)

(72) Inventors: Isabel Yishu Yang, Brighton, MA (US); Raj Agrawal, Cambridge, MA (US)

(21) Appl. No.: 18/070,745

(22) Filed: Nov. 29, 2022

Related U.S. Application Data
(60) Provisional application No. 63/284,914, filed on Dec. 1, 2021.

(51) Int. Cl. G06Q 40/00; G06Q 50/18

(52) U.S. Cl. CPC G06Q 40/12; G06Q 50/18

(57) ABSTRACT

Systems and methods for evaluating the outcome of a situation or investment opportunity and determining an “optimal” set of terms for an agreement between parties, one of whom may be involved in the situation and the other who may be providing funding to enable the first party to participate in the situation. Embodiments overcome the disadvantages of conventional approaches to evaluating and allocating risk in situations in which an outcome primarily depends on a binary event or sequence of such events.

### CROSS REFERENCE TO RELATED APPLICATION

This application claims the benefit of U.S. Provisional Application No. 63/284,914, filed Dec. 1, 2021, and titled “Systems and Methods for Constructing, Valuing, and Reselling Stakes in Legal Claims”, the contents of which is incorporated in its entirety (including the Appendix) by this reference.

### BACKGROUND

There are several types of business situations in which it is necessary to determine the possible financial values of an outcome and how best to allocate risk among the parties involved. These situations include litigation, potential mergers and acquisitions, investment strategies, and the setting of insurance premiums, among others. Such situations may also arise in non-business contexts, such as gambling or other forms of gaming.

One common aspect to these situations is that the outcome typically depends on a binary event, that is either an event happens, or it does not. For example, in the context of litigation, a party may win or lose, or a court may decide a motion in one of two ways. In a merger or acquisition, either the event occurs, or it does not. In the insurance context, either an event (i.e., a death, fire, or claim, for example) happens or it does not, and the premiums reflect the risk to an insurer in terms of the probability of the event happening. In some situations, an outcome may be a result of a finite sequence of binary-valued events, such as the litigation example mentioned wherein a Court may rule on a set of motions, with each such ruling impacting the value and/or likelihood of an outcome to the litigation.

In each of these situations, it may be necessary to determine a value of a positive outcome (i.e., the event happens, such as a party is awarded a judgment, or a merger is completed) and it may also be necessary to determine how best to allocate the risk of a negative outcome or result. It may also be necessary to determine a “best” or optimal set of terms to use in allocating the benefits or losses incurred as a result of an event occurring or not occurring.

One example of a situation involving both the value of an outcome and the terms used to allocate benefits or losses is that of funding a litigation. Litigation may cost multiple millions of dollars to pursue through trial, and judgments may range from several million to hundreds of millions of dollars. Because of these stakes, a party to a litigation, as well as those backing the party by paying for some or all the costs of litigation, would benefit from an approach that allows them to better understand how to structure their relationship. This may include consideration of the investment by the source of the funding for the costs and the return on that investment if the litigation is successful by reaching a judgement in favor of the party being funded, or a settlement to that party. The structure of the relationship (referred to as a funding agreement) may also include various terms, conditions, or factors (as non-limiting examples) that impact the allocation of risk between the funder and the party, and the return on investment to the funder under different circumstances. For example, a litigation funder may want to know how their return could vary based on a specific event that occurs (or fails to occur) during the litigation.

Embodiments of the disclosure overcome these and other disadvantages of conventional approaches to evaluating and allocating risk in situations in which an outcome primarily depends on a binary event or sequence of such events (e.g., a case winning/settling or losing), both individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

This disclosure is directed to systems, devices, and methods for determining how to optimally structure a relationship between a litigation funder and a party to that litigation. Although the following will be described in the context of litigation and more specifically, the funding of a litigation, the approach and techniques may be applied to other situations (typically involving a sequence of one or more events, each with a binary outcome) and used to determine (in whole or in part) the terms under which two parties enter into an agreement.

For example, the methodology described herein may be generalized to automate (1) asset valuation and (2) the appropriate sizing of an investment in an asset, subject to a set of configurable constraints, where the value of an asset is at least partially determined by an event with observed, binary outcomes, or a finite sequence of events, each with an observed binary outcome.

In this regard, note that the terminal value of an asset may depend on more than a single or multiple binary valued events. For example, in the context of litigation financing, the terminal value is determined by a combination of the case outcome (the binary event), award size (a continuous variable), duration (a continuous variable), and cost (a continuous variable).

Examples of other types or forms of investments to which the disclosed methodology may be applied include (but are not limited to) biotech investments, where the value of the underlying biotech venture hinges on securing regulatory approval for an invention or product; Mergers and Acquisition risk arbitrage, where the value of the investment hinges on whether the announced M&A transaction is eventually consummated; economic zone real estate investment, where the land value hinges on obtaining regulatory approval of the zoning proposal; and specialized after-the-event insurance, where the insurance premium and payout structure is determined by the chance of the underlying event occurring.

In one embodiment, the disclosure is directed to a method for evaluating the outcome of a situation (or investment opportunity) and determining an “optimal” set of terms for an agreement between parties, one of whom may be involved in the situation and the other of whom may be providing funding to enable the first party to participate in the situation. In one embodiment, the data processing flow and associated logic implemented as part of the method may comprise the following operations, functions, or processes:
Determine or “predict” a value for a term that is part of a transaction or agreement, such as one that impacts the outcome of a situation or opportunity being considered;
   In some embodiments, this may be determined by a term valuation model which takes the form of a probabilistic valuation model;
In one example, a possible outcome or outcomes for the situation may be a set of cash flows derived from an investment;
   In one embodiment, a joint distribution over a set of identified variables/factors that may impact an outcome may be formulated as a product of a first distribution that is a function of the outcomes (or a function of a final outcome) at a specific time and a second distribution that is a function of the factors/variables;
      In one embodiment, each of the first and second distributions are generated using one or more of machine-learning (ML) methods, historical data distributions, and subjective (expert) inputs;
   For each possible outcome (such as a set of cash flows), a probability of occurrence for that outcome is determined;
   A probability of occurrence weighted average of the net present value(s) of the possible outcome(s) is determined (sometimes referred to as the Expected Net Present Value or ENPV);
Given the valuation attributed to each of a set of terms from the valuation model, determine an “optimal” set of terms for the agreement covering the situation or opportunity;
   Determine or define a proposed set of terms for an agreement between parties to the situation;
      As a non-limiting example, the agreement may be an agreement to fund litigation for a party to a dispute being litigated;
      In some embodiments, an optimal configuration is a set of parameters (i.e., a specific funding term or terms) that maximizes funding objectives subject to funding constraints;
Determine or define a funding objective or objectives based on the valuation of a term or terms and the allocation of an award received from resolution of a situation, conditioned on a positive award amount;
Determine or define applicable constraints on a term of the agreement;
   The constraints may include global (i.e., averaged over all possible scenarios) and/or local constraints (i.e., scenario specific);
Perform an optimization process to determine a set of terms for an agreement that optimize the funding objectives, subject to the defined constraints.

In one embodiment, the disclosure is directed to a system for evaluating the outcome of a situation and determining an “optimal” set of terms for an agreement between parties, one of whom may be involved in the situation and the other of whom may be providing funding to enable the first party to participate in the situation. The system may include a set of computer-executable instructions stored in (or on) a memory or data storage element (such as a non-transitory computer-readable medium) and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to an entity seeking assistance in selecting the terms of an agreement, a specific agreement or type of agreement, a set of entities, or an organization, for example. Each account may access one or more services or processes, a set of which are instantiated in their account, and which implement one or more of the methods or functions described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, the exemplary or specific embodiments are not intended to be limited to the forms described. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a diagram illustrating a set of elements, components, functions, or processes that may be used in generating a valuation for a term in an agreement, in accordance with an embodiment of the disclosure;

FIG. 1(b) is a flow chart or flow diagram illustrating a method, process, operation, or set of functions that may be used in implementing an embodiment of the disclosure by valuing a set of terms for an agreement and generating an optimal set of terms;

FIG. 1(c) is a flow chart or flow diagram illustrating a method, process, operation, or set of functions that may be used in implementing an embodiment of the disclosure; and

FIG. 2(a) is a diagram illustrating elements or components that may be present in a computer device or system configured to implement a method, process, function, or operation in accordance with an embodiment of the system and methods described herein;

FIGS. 2(b), 2(c), and 2(d) are graphs illustrating a technique for generating a series of cash flows for each of three example contexts or situations;

FIG. 2(e) is a chart illustrating document types, extracted features, and how the extracted data impacts a factor or parameter in a model or models used to estimate an optimal set of terms for an agreement;

FIG. 2(f) is an illustration of a process flow for using the outcome, award, duration, and costs distributions to generate a model of the expected returns;

FIG. 2(g) is graph illustrating the proposed Pareto optimal frontier for funding terms, and the set of funding terms that satisfy all constraints (the “Funder Term Zone”);

FIG. 2(h) is a set of graphs and tables illustrating the main steps involved in the Term Stacking algorithm, the proposed optimization method for identifying the set of terms that satisfy the global and local constraints; and

FIGS. 3, 4, and 5 are diagrams illustrating an architecture for a multi-tenant or SaaS platform that may be used in implementing an embodiment of the systems and methods described herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, co-processor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored in (or on) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, the systems and methods disclosed herein may provide services through a SaaS or multi-tenant platform. The platform provides access to multiple entities, each with a separate account and associated data storage. Each account may correspond to an entity seeking assistance in selecting the terms of an agreement, a specific agreement or type of agreement, a set of entities, or an organization, for example. Each account may access one or more services or processes, a set of which are instantiated in their account, and which implement one or more of the methods or functions described herein.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments are directed to systems, devices, and methods for evaluating the outcome of a situation and determining an “optimal” set of terms for an agreement between parties, one of whom may be involved in the situation and the other of whom may be providing funding to enable the first party to participate in the situation. In some embodiments, an optimal configuration is a set of parameters (i.e., a specific funding term or terms) that maximizes funding objectives subject to funding constraints.

From one perspective, embodiments address and provide a solution to the following “problems” that arise in evaluating a term of an agreement and/or identifying one or more optimal terms for the agreement:
(1): Valuation of a funding term. In one embodiment, the valuation of a funding term equals the expected net present value (ENPV) of the term, which is the probabilistic analogue (and generalization) of discounted cash flow analysis. More specifically, for each sequence of cash flows, the approach computes the net present value of that cash flow. Then, the approach averages over these net present values, where each net present value is weighted by the occurrence probability of the associated cash flow sequence. Embodiments accurately specify a distribution on cash flows and estimate ENPV using a Monte Carlo simulation;
(2): Selecting funding terms under multiple objectives and constraints. While ENPV allows computation of a valuation for a specific term, it does not provide a way to select the funding term. To perform this function, the disclosed approach operates to find terms that optimize multiple funding objectives and satisfy various constraints. Since the resulting optimization problem is higher-dimensional, the approach uses what is referred to herein as the Term Stacking algorithm which finds terms that meet constraints in a computationally efficient manner; and
(3): Dynamically revaluing funding terms. Revaluing terms over time (e.g., for the purposes of reselling an interest in an outcome) is conceptually the same as reaching a valuation at time 0 due to the probabilistic approach disclosed. Specifically, the valuation of a term at time t>0 still equals ENPV, but this expectation is taken with respect to the cash flow distribution conditioned on previous and new information known about a case at time t. This ability to dynamically price and resell terms leads to the (theoretical) ability to securitize legal claims.

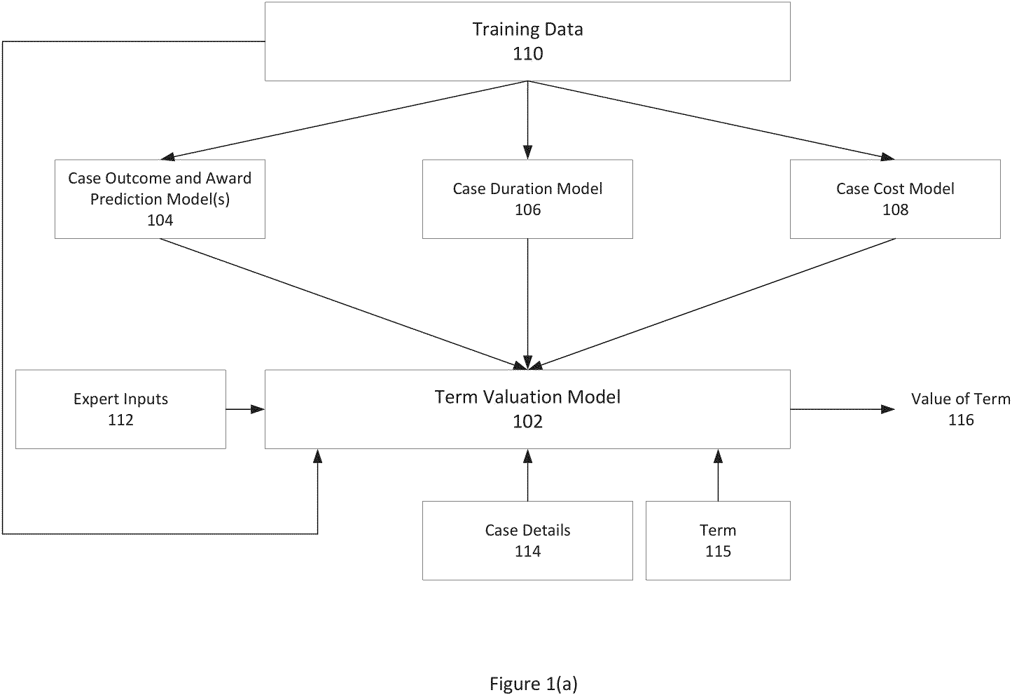

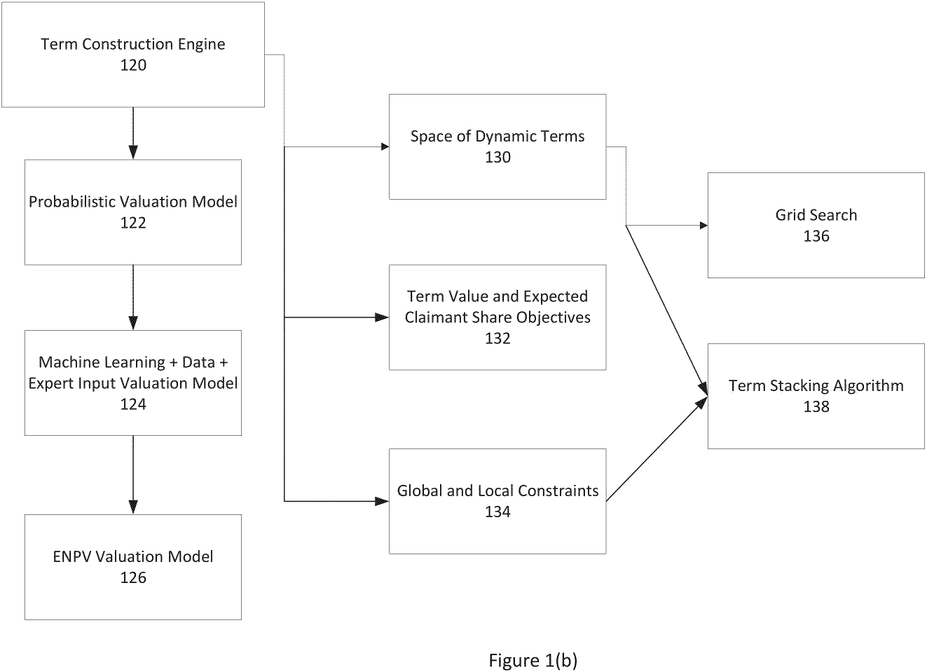

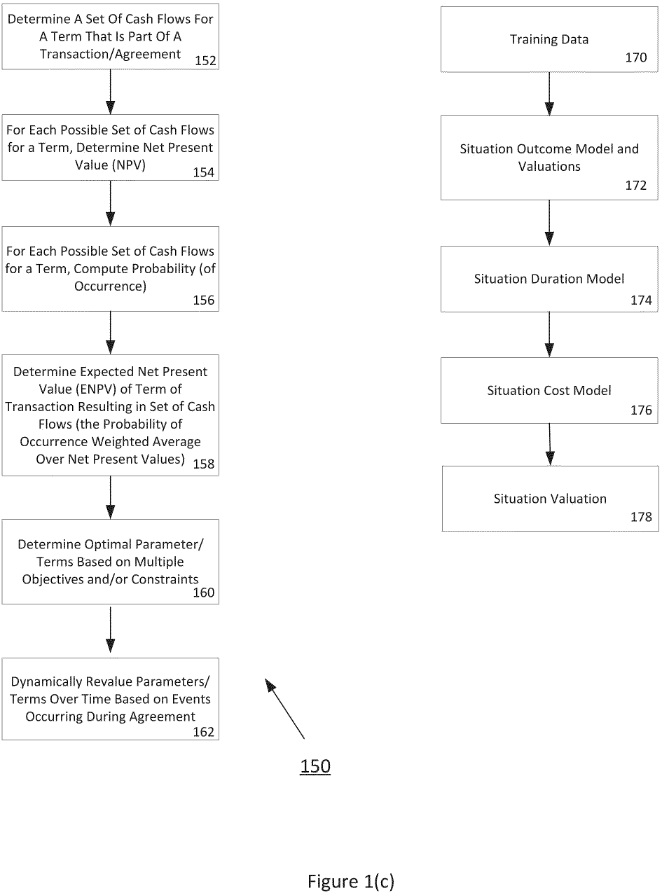

FIG. 1(a) is a diagram illustrating a set of elements, components, functions, or processes that may be used in generating a valuation for a term in an agreement, in accordance with an embodiment of the disclosure. As shown in the figure, a term valuation model (as suggested by element or processes 102) may consider or be dependent upon one or more inputs generated by other types of models or data processing flows. As a non-limiting example, these other models or data processing flows may include but are not limited to or required to include:
(1) a case outcome and award prediction model (as suggested by element or processes 104);
(2) a case duration model (as suggested by element or processes 106); and
(3) a case cost model (as suggested by element or processes 108),
with one or more of those models being trained using a set of training data (as suggested by element or processes 110) obtained from a set of documents (for uses where such data is available and relevant) or from another source. Although the figure indicates a use of Training Data 110 for training of Term Valuation Model 102, such data may also be used for training of one or more of the other models illustrated. Note that this approach treats the task as one that can be decomposed into a probabilistic distribution or distributions involving the relevant attributes (e.g., case outcome, award, duration, and cost, as examples).

A possible input to a term valuation model 102 is what is shown as “Expert Inputs” or data (as suggested by element or processes 112). This may take the form of an input from a lawyer or other subject matter expert (SME) with regards to one of the attributes based on the training data 110, as an example. The term valuation model 102 may also consider information that impacts the valuation of a term, or information regarding funding or distribution of an award, as non-limiting examples (as suggested by Case Details 114 in the figure, which may include events or decisions relevant to a case or situation as it progresses). Term valuation model 102 may also consider an existing value for a term (115) as an input. In one embodiment, an output of term valuation model 102 is a “predicted” value for a term in an agreement 116.

FIG. 1(b) is a flow chart or flow diagram illustrating a method, process, operation, or set of functions that may be used in implementing an embodiment of the disclosure by valuing a set of terms for an agreement and generating an optimal set of terms. As described previously and in greater detail herein, this figure illustrates a process flow or set of components that may be used to determine or identify a set of terms for an agreement that exist in a defined funding space and optimize achieving one or more identified objective(s), subject to a specific set of constraints (if applicable).

In one embodiment, the elements, components, or functional routines illustrated may operate to implement the following processes, functions, methods, or operations:
Term Construction Engine (as suggested by element or processes 120):
   Inputs:
      Valuation Modelvaluation of a proposed term based on available case attributes, waterfall structure, or other available and relevant information;
      Funding Space - space of possible funding terms (a set of possible funding terms (in some embodiments, all such possible terms), where each term is represented by a finite set of parameters);
      Funding Objectives - vector of term performance metrics;
      Funding Constraints - constraints a term must satisfy;
      Optimization Routine - an optimization method used to perform the constrained optimization task;
   Output(s):
      Terms in the funding space that optimize the funding objectives subject to the constraints using the optimization routine;
Probabilistic Valuation Model (122):
   This is a model that specifies a range of possible scenarios (e.g., sequences of possible cash flows), and a probability for the occurrence of each scenario or sequence to derive a valuation for a funding term;
      In some embodiments, a distribution that is part of the probabilistic valuation model is generated by combining one or more of a trained machine learning (ML) model or other form of model (such as a statistical model) that models the merits of a case or situation and operates to “predict” an outcome, historical data (e.g., a distribution of follow-on proceedings or events), and “expert” inputs or evaluations regarding outcomes of valuations (e.g., maximum, minimum damages expected) (as suggested by “ML+Data+Expert Valuation Model”, 124);
      The valuation model (122) then determines a value for the specific term using an ENPV valuation model or process (126) in which the value of a term is set equal to the expected discounted value of all present and future cash flows a term is expected to generate, with each such cash flow weighted by the probability of its occurrence;
The output(s) of Term Construction Engine 120 are then modified or adjusted (as needed) to account for variation in a term over time, as suggested by the Space of Dynamic Terms (process or element 130);
   As a non-limiting example, this may be a term that is a function of a stake in an award resulting from a case, such as a multiple of cost or committed capital that varies as a function of the duration of a case or situation;
The Term Value and Expected Claimant Share Objectives are then defined (process or element 132);
   This may be the goals or objectives of an optimization process or multi-task model;
      For example, this may be used to determine or define a funding objective or objectives based on the valuation of a term and the distribution of any award received from resolution of a situation, conditioned on a positive award amount;
The global (averaged over all or a set of possible scenarios) and/or local (scenario specific) constraints that are applicable to a term of an agreement are then specified (process or element 134); and
An optimization process is then performed to determine a set of terms for an agreement that optimize the funding objectives, subject to the defined constraints;
   In some embodiments, the optimization process may include a grid search process (136) that searches and evaluates combinations of duration and allocation of an award;
      For each duration, this process generates a grid of multiples and fractional stakes in an award or outcome. A search process then evaluates combinations of such duration/awards that satisfy the funding constraints;
   In some embodiments, the optimization process may be an algorithm (referred to as the “Term Stacking Algorithm” herein, process 138) that has been found to be efficient under a limit of two objectives or goals;
      This optimization process has been found to efficiently solve the optimization problem over the space of Dynamic Terms when the local constraints are conditional on a specific duration, and when there are at most two Funding Objectives or Goals.

As a further example, in some embodiments, where such data is available and relevant, a model or models may be trained using a set of training data extracted from documents describing a situation and the values of one or more binary valued outcomes that occurred during the development of the situation;
In some embodiments, this may comprise multiple trained models, such as a trained model for each of:
   An outcome of a situation;
   A prediction of the value of an outcome;
   A prediction of the duration of a situation until the outcome is reached; and
   A prediction of the cost of participating in the situation until the outcome is reached.

As disclosed, in some embodiments, this may be determined by inputting a set of parameters that characterize the situation into a deterministic or other form of model, where the characteristics may include one or more of:
Type of situation or dispute;
Expected cost of pursuing situation to closure or abandonment;
Expected timeframe to bring situation to closure or abandonment;
Maximum amount of value obtainable from situation;
   This may take the form of increased revenue, a windfall amount of increased value, a judicial award, a settlement amount, etc.;
The disclosed modeling approach (e.g., a machine learning (ML) model + expert inputs, as suggested by the flow diagram in FIG. 1(b)) may be used to specify the probability distribution over 4 uncertain quantities in a situation: the outcome of the case (the chance of a win or loss), an award size (how much is awarded if the case wins), the case duration, and the cost of a case or cost of getting to a specific stage of a case. Once the approach has developed a distribution on these 4 quantities, it obtains a distribution over cash flows which, in turn, allows the approach to obtain a valuation using the expected net present value (NPV) of cash flows.

In one example, the possible outcomes of a case or situation may be expressed as a set of cash flows derived from an investment;
In one embodiment, it is determined that a probability distribution on three variables (in the example of litigation funding these are (1) award/judgement size, (2) duration of litigation, and (3) cost of participating in litigation to reach stage of award) is sufficient to a generate a distribution of the cash flows;
In one embodiment, a joint distribution over the identified variables/factors may be formulated as a product of a first distribution that is a function of the outcomes (or a final outcome) at a specific time and a second distribution that is a function of the factors/variables noted;
   In some embodiments, the factors/variables may represent the factorable (i.e., independently varying) contributions to determining the probability of an outcome or value for an outcome or term;
   In one embodiment, each of the first and second distributions are generated using one or more of machine-learning methods, historical data distributions, and qualitative (expert) inputs;
   In one embodiment, the second distribution may be factored into separate distributions each dependent on one of the three variables, with each able to be estimated using statistical and/or machine learning techniques;
In one embodiment, a Monte Carlo simulation may be used to compute a value for the expected net present value of an outcome or term based on the derived distributions;
For each possible outcome, a probability of occurrence for that outcome is determined;
A probability of occurrence weighted average of the net present values of the possible outcomes is determined (the ENPV).

Given the valuation attributed to each of a set of terms, the process determines an “optimal” set of terms for the agreement covering the case or situation;
Determine or define a proposed set of terms for an agreement between parties to the situation;
   As a non-limiting example, the agreement may be an agreement to fund litigation for a party to a dispute being litigated;
   In some embodiments, the terms of an agreement may take the form of an assumed relationship between certain parameters or characteristics of a situation, where the relationship may be a function of the duration, expected value, or another characteristic of the situation (such as the type of dispute, location of litigation, etc.);
   In some embodiments, the amount of funds provided, or costs paid for may vary and be related in different ways to an expected payout;
   In some embodiments, an optimal configuration is a set of parameters (i.e., a specific funding term) that maximizes funding objectives subject to funding constraints.

FIG. 1(c) is a flow chart or flow diagram illustrating a method, process, operation, or set of functions 150 that may be used in implementing an embodiment of the disclosure. As shown in the figure, at step or stage 152 the processing operates to determine or “predict” a value for a term that is part of a transaction or agreement, such as one that impacts the outcome of a situation being considered. In one example, the possible outcomes may be a set of cash flows derived from an investment. The set of cash flows may correspond to the value of a set of outcomes to a situation that is the basis for an agreement. Each cash flow (which may be a single amount or a sequence of valuations) of the set of cash flows may represent a result of a particular set of events for a larger process, such as a legal dispute, negotiation, etc.

At step or stage 154, the process determines a net present value (NPV) of each of the set of possible cash flows. The process then determines for each possible set of cash flows for a term, the probability of occurrence, as suggested by step or stage 156. As described herein, this may involve use of a model, such as a Monte Carlo model, to estimate the probabilities.

Next, the process determines the expected net present value (ENPV) of the term or aspect of the transaction resulting in each cash flow of the set of cash flows, as suggested by step or stage 158. This represents the probability (of occurrence) weighted average over net present values for the term. As described herein, this may involve use of a formulation of the factors that determine an outcome as a set of conditional distributions.

Given the valuation attributed to each of a set of terms, the process then determines an “optimal” set of terms for the agreement covering the transaction. This includes determining or defining a funding objective or objectives based on the valuation of a term and the distribution of an award received from resolution of a transaction (as conditioned on a positive award amount), determining or defining one or more constraints on a term of the agreement, and performing an optimization process to determine a set of terms for an agreement that optimize the funding objectives, subject to the defined constraints, as suggested by step or stage 160.

Embodiments of the illustrated process may also include dynamically revaluing a term or terms over time based on events occurring during the duration of the situation or transaction that is the basis for the agreement, as suggested by step or stage 162.

The set of functions, processes, or operations labeled with numbers 170-178 represent an example set of processes that may be used to generate a valuation model for a term or event, as disclosed herein and described with reference to FIGS. 1(a) and 1(b). This sequence or combination of models is based on representing a term or event as a joint distribution between an outcome, value of the outcome, duration, and cost of the term or event. As suggested by the use of training data (170), one or more of the models (172,174, or 176) may be trained (at least in part) by data extracted from a set of documents that contain information and data concerning a set of events, disputes, contracts, situations, etc.

Additional details regarding the overall process flow and implementation of the stages of the data processing described with reference to FIGS. 1(a), 1(b), and 1(c) are presented in the following sections.

In the following discussion and derivations, the symbols below represent the indicated concepts or variables:
A award / settlement amount
T remaining case duration
B committed capital / budget for funding a case
O case outcome
Cₜₒₜₐₗ total cost of a case
Cₜ cash flow at time t
X training data matrix
Y response matrix
rₘᵢₙ funder’s minimum annual rate of return (cost of capital)
r_{IRR} expected IRR
Iₜ information known about a case at time t
F funding term which is defined by multiples on committed capital and percentages in the award
Θ space of possible funding terms

$${\left\{{t}_{k}\right\}}_{k = 1}^{K}$$
times at which the funder’s multiple on budget and percentage in the award changes
mₖ multiple on B the funder receives if the case takes between tₖ and tₖ₊₁ years
fₖ percentage of A the funder receives if the case takes between tₖ and tₖ₊₁ years
E[NPV(rₘᵢₙ, F)] the expected NPV of a funder’s investment
E[RNPV(rₘᵢₙ, F)|Iₜ] the expected NPV of a funder’s investment in a case at time t
To size an investment into a litigation finance investment (i.e., select a funding term), the approach requires a way of determining the value of a fixed funding term. The expected net present value (ENPV) of a funding term is used to reach a valuation, which is the probabilistic analogue of discounted cash flow analysis.

### Estimating the ENPV of a Funding Term

### Determining the ENPV of an Arbitrary Investment

Suppose an investment terminates after T years. During this period of T years, suppose an investment generates cash flows

$${\left\{{C}_{t}\right\}}_{t = 0}^{T} ,$$

where Cₜ ∈ (-∞,∞) equals the net cash flow at time t. Let rₘᵢₙ ∈ [0, 1] denote the minimum annual rate of return the funder demands (i.e., her cost of capital). Then, the valuation of the investment equals the expected net present value of cash flows or

$$E \left[\sum {}_{t = 0}^{T} {C}_{t} \left(1 +\right)\right)$$

rₘᵢₙ)^{-t}], which averages over all possible sequences of cash flows¹, weighted by the probability of each cash flow occurring. If ENPV is greater than or equal to 0, then the funder is expected to exceed her cost of capital. Hence, she might invest in the project. Otherwise, she will not invest.

¹ In the economics literature, NPV is often called “discounted utility.” Hence, valuing an investment based on ENPV can be motivated from the perspective of expected utility theory, which provides a theoretical justification for handling uncertainty via expectations.

From ENPV, the disclosed approach derives the expected internal rate of return (IRR) of the investment, which generalizes the traditional definition of IRR to handle uncertainty:

The expected IRR of an investment is the discount rate r_{IRR} such that ENPV equals 0. If r_{IRR} is larger for investment X1 than investment X2, then that implies the expected return (after normalizing for duration and investment size) is higher for X1. While ENPV and r_{IRR} lead to a simple decision-making framework to coherently value and compare between investments, computing ENPV can be challenging; it requires specifying a probability distribution on

$${\left\{{C}_{t}\right\}}_{t = 0}^{T} ,$$

where both the size and number of cash flows can be uncertain quantities. In the next section, a process for constructing this distribution on cash flows for investments into legal cases is presented.

### Specifying the Cash Flow Distribution to Compute ENPV

Work related to the disclosure indicates that it suffices to specify a probability distribution on four variables - outcome, award size, duration, and cost of the case - to generate a distribution on cash flows. The following starts with the simplest setting, and then describes straightforward generalizations.

### Assumptions on Cash Flows

Assume, that at time t = 0, a funder commits B > 0 dollars to pay for legal expenses in exchange for a portion of a possible award.² Since the funder cannot use committed capital for other investment purposes, C₀ = -B. At time T, the case concludes and a judgement or settlement in the amount of $A is awarded, where A equals zero if the case loses. It is assumed that the payout of the funding term F depends on the award amount, duration, and budget of the case. Then, C_{T} = F(A, T, B) + max(0, B - Cₜₒₜₐₗ), where F(A, T, B) is the payout of term F, Cₜₒₜₐₗ is the realized cost of the case, and max(0, B - Cₜₒₜₐₗ) represents any unused budget (assumed to be disbursed back to the funder). The remaining T-1 cash flows, C₁, ..., C_{T-1}, are assumed to be equal to 0. Since all cash flows are deterministic functions of A, T, B, Cₜₒₜₐₗ, it suffices to specify a probability distribution on the unknown quantities (A, T, Cₜₒₜₐₗ) to induce a probability distribution on the two non-zero cash flows C₀ and C_{T}.

² Here time is relative to when the funder first observes the case. So, t=0 does not represent the filing date of the case but rather the time when the funder first observes the case.

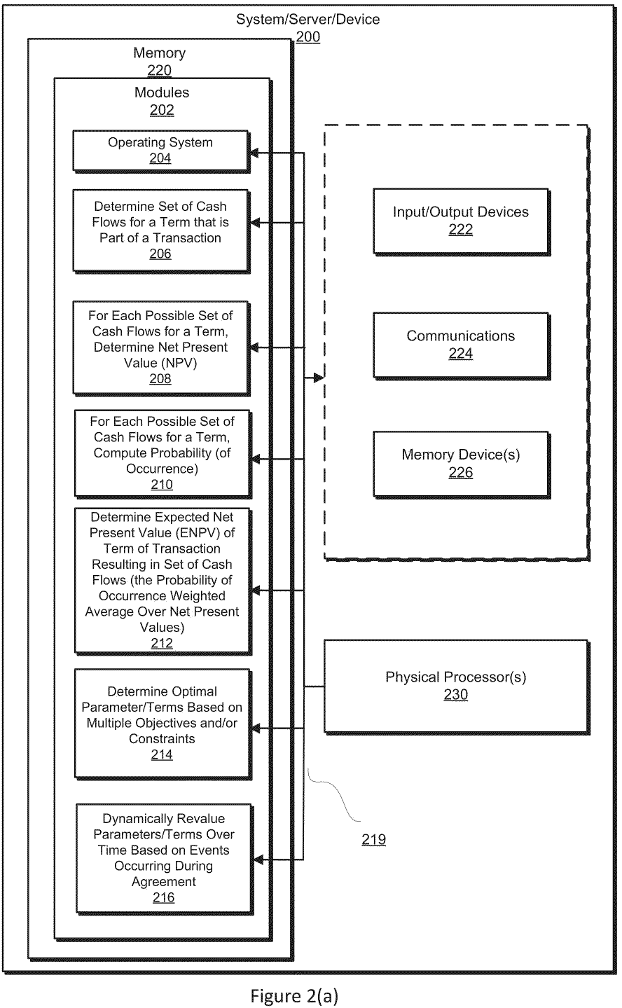

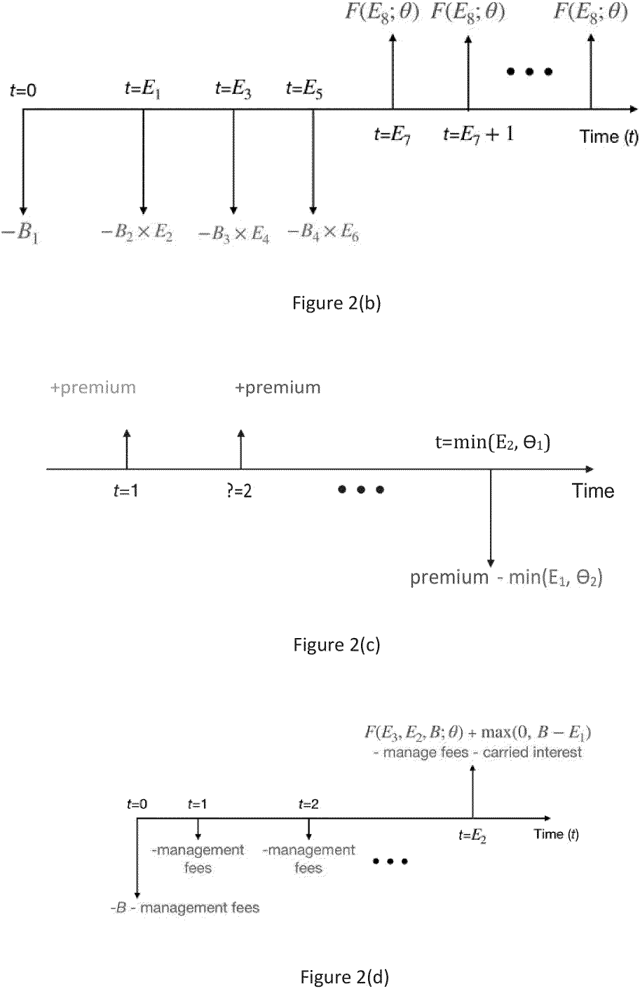

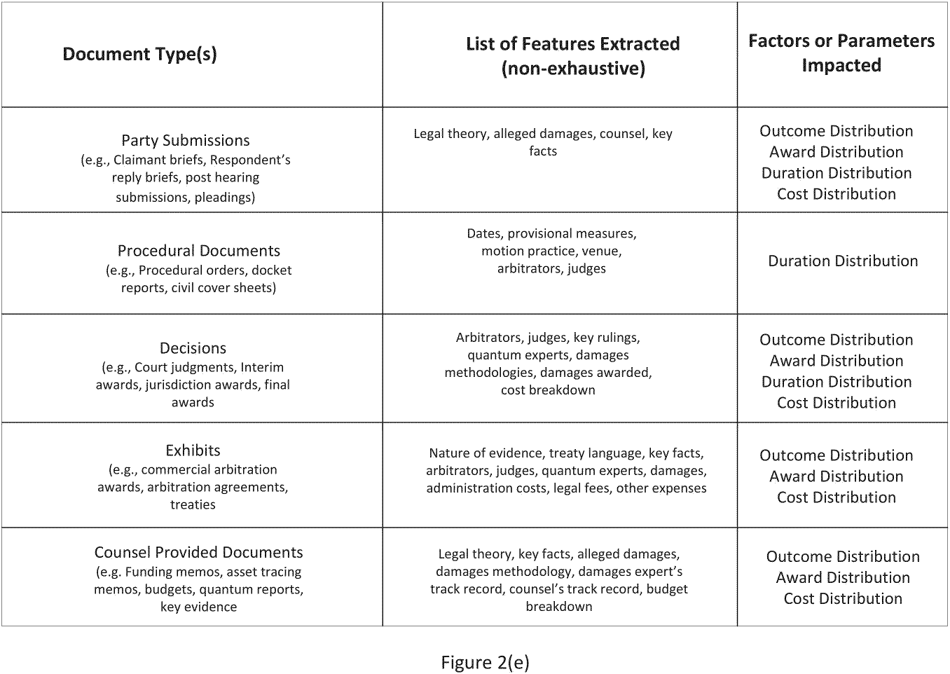

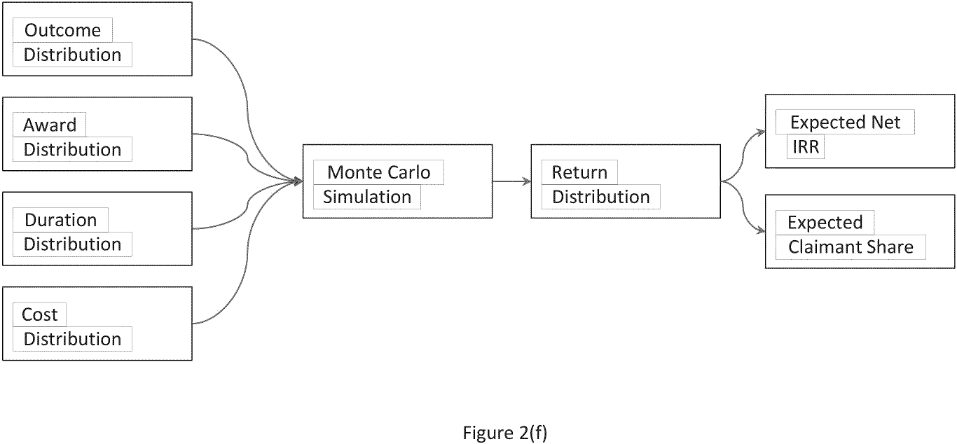

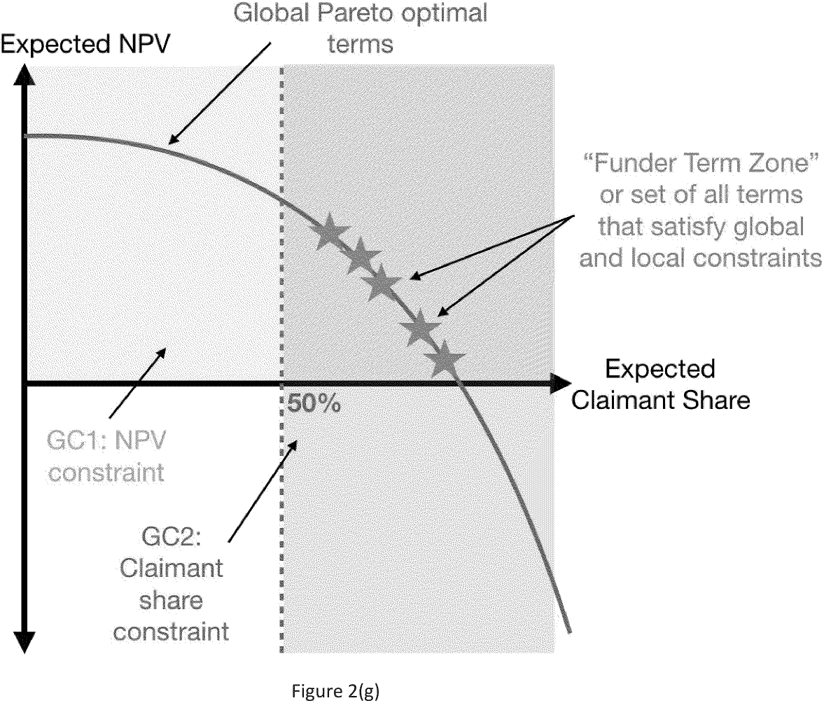

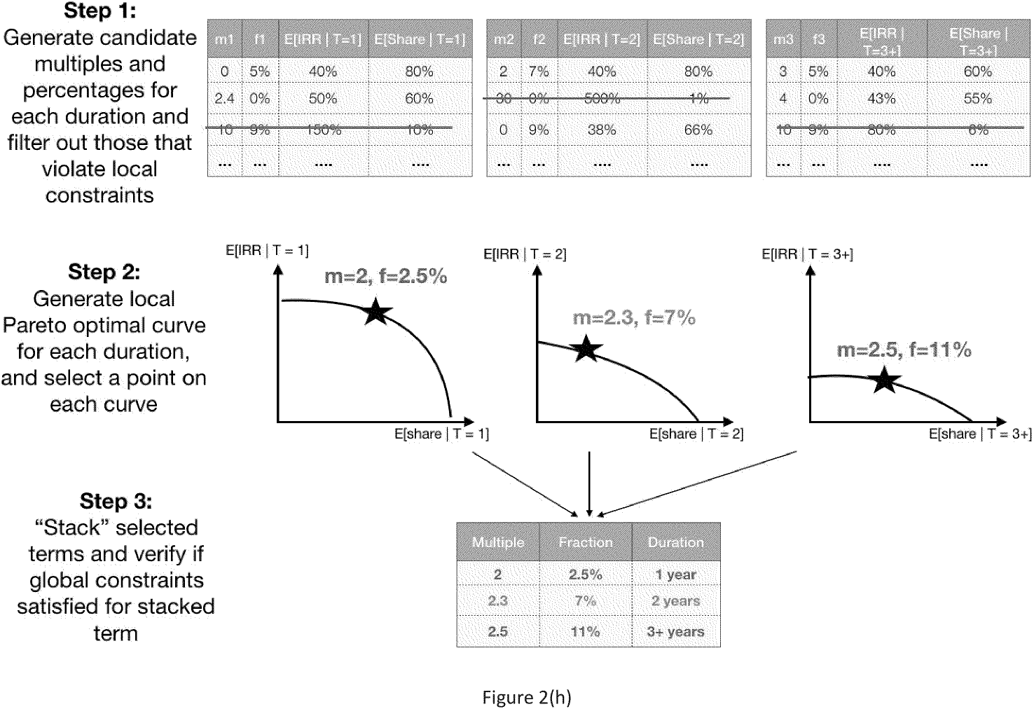

FIGS. 2(b), 2(c), and 2(d) are graphs illustrating a technique for generating a series of cash flows for each of three example contexts or situations and are described in further detail herein.

### Specifying Outcome, Award, Cost, and Duration Distribution(s)

The approach estimates the conditional probability distribution of outcome, award size, duration, and cost given known attributes about a case (e.g., the attorneys representing each party, judge, court, laws cited, amount of damages claimed) at the time of investment. This conditional distribution is denoted as Pr(O=o, A=a, T=t, Cₜₒₜₐₗ= c| x), which is the conditional probability of a case with attributes x having an outcome o (e.g., win, loss, or settlement), award size a, duration T, and cost c. To estimate Pr(O, A, T, Cₜₒₜₐₜ | x), the approach assumes access to historical training data, represented by a numerical data matrix X and response matrix Y. The rows of X represent different historical cases, and the columns of X represent different features known about the case at the time of investment.³ Each row of Y corresponds to the same cases in X, and the columns of Y = [Y_{O} Y_{A} Y_{T} Y_{C} ] denote the outcome, award amount, duration, and cost associated with each case, respectively.

³ Categorical case attributes (e.g., attorneys, judges, court, law cited) are converted into numerical values for X via one-hot encoding. Textual case attributes (e.g., text extracted from case documents) are converted into numerical values via language embeddings (e.g., using machine learning methods such as Word2Vec, GloVe, Doc2Vec, SentenceBERT).

To estimate Pr(O, A, T, Cₜₒₜₐₗ | x) from (X, Y), the distribution is re-written as a product of one-dimensional distributions by the chain rule of probability:

$$\begin{matrix}Pr \left(O , A , T , {C}_{t o t a l} \left|x\right)\right) = \\ Pr \left(O \left|x\right)\right) Pr \left(T \left|x , O\right)\right) Pr \left({C}_{t o t a l} \left|x , O , T\right)\right) Pr \left(\left(A\right| x , O , T , {C}_{t o t a l}\right) .\end{matrix}$$

Based on this factorization, machine learning methods can be used to estimate the four one-dimensional probability distributions on the left-hand side of Equation 1. For example, the outcome distribution Pr(O | X) can be estimated using a multinomial logistic regression model (e.g., via kernel, deep learning, or tree-based multinomial logistic regression procedures). Specifically, X is used as the input data matrix and Yₒ as the response in the model fitting procedure. To estimate Pr(T | X,O), a survival model is used, where the survival model is trained using [X Yₒ] as the input data matrix and Y_{T} as the response. Some common choices of survival models include the Cox Proportional Hazard model and the Random Survival Forest model. The two remaining distributions can be estimated in a similar fashion.

### Computing ENPV via Monte Carlo Simulation

Computing ENPV under the joint distribution P(O, A, T, Cₜₒₜₐₗ | x) requires a computationally intensive integration over A, T, Cₜₒₜₐₗ, and O. As an alternative, in one embodiment, the approach uses a Monte Carlo simulation to perform integration. First, draw 1 ≤ m ≤ M samples (O^{(m)}A^{(m)}, T^{(m)},

$$\left({C}_{t o t a l}^{\left(m\right)}\right)$$

~ Pr(O, A, T, Cₜₒₜₐₗ | x). Next, the approach computes the resulting cash flows

$${\left\{{C}_{t}^{\left(m\right)}\right\}}_{t = 1}^{{T}^{\left(m\right)}}$$

based on the sampled award, duration, and cost. By the Central Limit Theorem, ENPV equals

$$\frac{1}{M} {\sum }_{m = 1}^{M} \left[{\sum }_{t = 0}^{{T}^{\left(m\right)}} {C}_{t}^{\left(m\right)} {\left(1 + {r}_{min}\right)}^{- t}\right] + {O}_{p} \left(\frac{1}{\sqrt{M}}\right)$$

where Oₚ

$$\left(\frac{1}{\sqrt{M}}\right)$$

is the Monte Carlo error term that decreases at rate square root of M with probability tending to 1. Hence, for M large (e.g., M = 10⁴ Monte Carlo simulations), the approach can effectively approximate ENPV with negligible error.

FIG. 2(e) is a chart illustrating document types, extracted features, and how the extracted data impacts a factor or parameter in a model or models used to estimate an optimal set of terms for an agreement. Categorical case attributes (e.g., attorneys, judges, court, or law cited, as examples) extracted from case documents are converted into numerical values for X via one-hot encoding. Textual case attributes (e.g., raw text extracted from party submissions, for example) are converted into numerical values via language embeddings. A variety of methods, such as Word2Vec, GloVe, Doc2Vec, and SentenceBERT, can be used for such embeddings. Given the large number of features extracted, at least several hundred to thousand data points are needed for accurate estimation.

FIG. 2(f) is an illustration of a process flow for using the outcome, award, duration, and costs distributions to generate a model of the expected returns. Specifically, once each of the one-dimensional distributions in Equation 1 are estimated, Monte Carlo simulation can be used to generate cash flows from Pr(O, A, T, Cₜₒₜₐₗ | x). Given these simulated cash flows, ENPV can be computed. By finding the discount rate such that ENPV equals 0, the expected net IRR can be computed.

### Selecting Terms Under Multiple Objectives and Constraints

To this point, the description of an embodiment has assumed the terms are provided. In practice, terms are typically selected through negotiations between the funder and Claimant (and sometimes other stakeholders). In the following is described a method of constructing the “Funder Term Zone” or a set of terms a funder would theoretically consider to underwrite a case. This zone can be used for purposes of a negotiation; a funder might initiate the negotiation by selecting the term in the “Funder Term Zone” that maximizes expected return and move down the list (in decreasing order of expected return) as the negotiation process continues. To construct this zone, an embodiment of the disclosed approach requires four inputs:
1. Funding space: space of possible funding terms (a set of possible funding terms (typically all such terms), where each term is represented by a finite set of parameters);
2. Funding objectives: performance metrics associated with a term (e.g., expected valuation of the term);
3. Funding constraints: constraints a term must satisfy; and
4. Optimization routine: an optimization method to perform the constrained optimization task.
Mathematically, the “FunderTerm Zone” equals the set of terms that are Pareto optimal with respect to the objectives in (2), satisfy the constraints in (3), belong to the space in (1), and are found using the optimization routine in (4). In some embodiments, an optimal configuration is a set of parameters (i.e., a specific funding term) that maximizes funding objectives subject to funding constraints. The following describes how to select each input.

### Funding Space

To perform the optimization, the approach needs to define a space of possible funding terms to search over. In litigation finance, a common way to structure terms is by taking a multiple m on committed capital B and a percentage ƒ in the award A (where m and ƒ may depend on how long the case takes due to the time value of money). To this end, one can define the space of funding terms 0 as all terms F whose payout structure can be written as follows:

$$F \left(A , T , B\right) = \left\{\begin{matrix}min \left(A , {m}_{1} B + {f}_{1} A\right) \\ min \left(A , {m}_{2} B + {f}_{2} A\right) \\ \begin{matrix} \\ min \left(A , {M}_{k} B + {f}_{K} A\right)\end{matrix}\end{matrix} \begin{matrix}\text{if} {t}_{0} \leq T < {t}_{1} , \text{where} {t}_{0} = 0 \\ \text{if} {t}_{1} \leq T < {t}_{2} \\ … \\ \text{if} {t}_{k} \leq T \leq {t}_{K + 1} , \text{where} {t}_{K + 1} = ∞\end{matrix}\right)$$

for some fixed integer K (indicating how often multiples and percentages in the award change), non-negative vectors m ∈ R^{K}, ƒ ∈ R^{K}, t ∈ R^{K}, and fixed budget B ≥ 0.

As an example: Suppose K = 5 and the tᵢ occur at 1-year increments. Then, Θ consists of all funding terms whose multiple on budget and percentage in the award vary for the first 5 years. Since F is defined by a total of 2 K parameters (i.e., m and ƒ), Θ is 2 K dimensional. If K is large, then terms are more sensitive to changes in duration. For example, instead of 1-year increments as in the above example, setting K = 10 and letting tᵢ equal 6-month increments yields terms that change semi-annually.

### Funding Objectives

From the perspective of the funder, there are typically two competing interests: (1) meeting the return target rₘᵢₙ for the investment, and (2) leaving the Claimant with a large enough share of the award (e.g., to avoid reputational risks that may prevent future deals). Maximizing (1) or (2) individually leads to trivial terms. In particular, allocating 100% of the award to the funder maximizes (1) whereas allocating 0% of the award to the funder maximizes (2). Instead, in some embodiments, the disclosed approach seeks to jointly optimize the objectives (1) and (2) in expectation⁴:
O1: ENPV of the term F discounted at rate rₘᵢₙ. We denote this quantity as E[NPV(rₘᵢₙ, F)], where higher is better.
O2: Expected Claimant share of the award in the event of a win or settlement. This quantity equals E
$$\left[\frac{A - F \left(A , T , B\right)}{A}\right)$$
| A > 0] , where
$$\frac{A - F \left(A , T , B\right)}{A}$$
equals the fraction of the award received by the claimant, and higher is better.
Typically, O1 and O2 are in conflict or tension with each other: to increase O1, a funder needs to take a larger portion of the award which decreases O2. However, this tradeoff between O1 and O2 may not always hold as shown in the example below.

⁴ The realized discounted return and Claimant share might be far from O1 and O2, respectively, on a single-case basis. Nevertheless, optimizing O1 and O2 lead to predictable behavior at the portfolio level through diversification.

As an example, suppose with probability 0.5 the case takes 1 year and with probability 0.5 the case takes 5 years. If the case takes 1 year, suppose A = $10M and Cₜₒₜₐₗ = $1M with probability 1. If the case takes 5 years, suppose A = $50M and Cₜₒₜₐₗ = $5M with probability one. Assume B=$5M, and rₘᵢₙ = 35%. Consider the following terms:

$$\begin{matrix}F \left(A , T , B\right) = A \left(i f 0 < T < 5\right) o r 0 \left(i f T \geq 5\right) \\ \text{and} \\ \tilde{F} \left(A , T , B\right) = .45 A \left(i f 0 < T < 5\right) o r .45 A \left(i f T \geq 5\right) .\end{matrix}$$

Then, F and F̃ leave the Claimant with an expected share of 50% and 55%, respectively. But

$$E [ \text{NPV(} \text{.35, F)] = -5 + 0} \text{.5(1} {\text{.35)}}^{- 1} [ 10 + 4 ] + 0.5 [ 0 ] = \$ .2 M$$

while

$$E [ \text{NPV(} \text{.35, F)] = -5 + 0} \text{.5(1} {\text{.35)}}^{- 1} [ 4 + 4 ] + 0.5 ( 20 ) = \$ .66 M .$$

Hence, F̃ is uniformly better in terms of O1 and O2. Intuitively, F is undesirable because it takes too much of the award for short durations and too little for long durations.

In one embodiment, the approach jointly optimizes O1 and O2 by identifying terms which are global Pareto optimal, where F is global Pareto optimal if there does not exist another term F̃ such that both O1 and O2 are larger for F̃ than for F.

Hence, under global Pareto optimality, selecting between different terms is effectively a “zero-sum” game; a term that has a better O1 value relative to another term must have a worse O2 value. While global Pareto optimality removes terms that are uniformly worse than other terms, it still results in terms a funder would likely not consider. For example, the term in which the funder takes 100% of the award is global Pareto optimal since it maximizes O1 and the term in which the funder takes 0% of the award is global Pareto optimal since it maximizes O2. To remove such extreme terms, and focus on terms a funder might consider, we incorporate constraints in the next section.

### Funding Constraints

The first of the two constraints restrict minimum values for O1 and O2, ensuring that the funder is expected to meet her return target and the Claimant is expected to retain the majority of the award:
GC1: O1 ≥ 0 (i.e., expected IRR exceeds funder’s cost of capital rₘᵢₙ)
GC2: O2 ≥ 50%
GC1 leads to predictable behavior at the portfolio level through diversification. For example, by the Strong Law of Large Numbers, as the number of invested cases increases, the realized portfolio IRR will exceed rₘᵢₙ with probability tending towards 1 (assuming each investment satisfies GC1 and the distribution inputs are correct). Unfortunately, in practice, there is a limit to the amount of investment, and hence the level of diversification to reduce variance. To reduce variance without increasing the amount of funds available for investment, we reduce the spread of the terms themselves by introducing local constraints; local constraints make returns more stable across different possible case durations.

As an example, suppose a case takes 1 or 2 years with equal probability. Suppose the expected NPV conditional on duration for F and F̃ are as follows:

$$E \left[N P V \left({r}_{min} , F\right) \left|T = 1\right)\right] = 100 , E \left[N P V \left({r}_{min} , F\right) \left|T = 2\right)\right] = - 99$$

and

$$E \left[N P V \left({r}_{min} , \tilde{F}\right) \left|T = 1\right)\right] = 1 , E \left[N P V \left({r}_{min} , \tilde{F}\right) \left|T = 2\right)\right] = 1.$$

Then, E[NPV(rₘᵢₙ, F)] = E[NPV(rₘᵢₙ, F̃)) = 1 so both terms meet GC1. However, F̃ has lower variance and a more stable return profile than F. Hence, F̃ has a better risk-adjusted expected return.

Based on this example, a term might satisfy GC1 and GC2 if the expected NPV or expected Claimant share conditional on a particular duration range is large enough to offset poor performance for other duration ranges. To make the performance of a term robust across duration (and reduce variance), consider the following two constraints which are the local analogues of GC1 and GC2:
LC1: Conditional on the case taking between tₖ and tₖ₊₁ years, the expected IRR exceeds a user-specified threshold of rₖ ∈ (-∞, ∞) for 0 ≤ k ≤ K; and
LC2: Conditional on the case taking between tₖ and tₖ₊₁ years, the expected claimant share exceeds a user-specified threshold of cₖ ≥ 0 for 0 ≤ k ≤ K.
If rₖ = rₘᵢₙ and cₖ = 50% for all k, then terms that satisfy LC1 and LC2 are universally robust against duration in the following sense; no matter how long the case takes, the expected return and expected Claimant share conditional on that duration meet the target IRR and Claimant share levels.⁵

⁵ In practice, some of the rₖ and cₖ must be set smaller than rₘᵢₙ and 50%, respectively, especially for long duration scenarios. For example, suppose tₖ = 10 years, rₖ = 35%, and cₖ = 50%. Then, it is unlikely that there exist any terms such that the expected IRR conditional on the case taking longer than 10 years exceeds 35% and expected Claimant share conditional on a 10 year plus duration exceeds 50%.

A final constraint concerns Pareto optimality, but now conditional on duration. LC3: there is no other term F̃ ≠ F and 0 ≤ k ≤ K such that both E[NPV(rₘᵢₙ, F̃) | tₖ ≤ T < t_{k+1]} and E

$$\left[\frac{A - \tilde{F} \left(A , T , B\right)}{A}\right)$$

|A > 0, tₖ ≤ T < tₖ₊₁] is larger than that of F. Any F that satisfies such a constraint is called local Pareto optimal. Proposition: If F is global Pareto optimal, then F is local Pareto optimal.

By the above, LC3 adds no new additional constraints but nevertheless provides additional insights about global Pareto optimality; if a term is global Pareto optimal, then that term is locally Pareto optimal for every duration range (tₖ, tₖ₊₁). In general, local pareto optimality does not imply global pareto optimality as will be discussed herein.

### Optimization Routine

FIG. 2(g) illustrates how the different proposed constraints and objectives result in the “Funder Term Zone”, which is the set of terms the funder might consider to underwrite a litigation finance investment. Specifically, each term is associated with two performance metrics: the expected NPV (objective 01) and expected claimant share (objective O2). FIG. 2(g) shows the possible values (O1, O2) can take for terms in 0, the space of all possible terms. The solid pink line corresponds to all points (O1, O2) that are Pareto optimal (i.e., there does not exist any terms with (O1, O2) above the solid pink line). The orange region corresponds to all terms that satisfy GC1 (i.e., have an expected NPV greater than 0) while the pink region corresponds to all terms that satisfy GC2 (i.e., have an expected claimant share greater than 50%). The green stars denote the set of all terms that not only satisfy GC1 and GC2, but also local constraints LC1-LC3. Terms corresponding to these green stars define the “Funder Term Zone”. To find terms that belong to the “Funder Term Zone”, the approach developed and uses what is referred to herein as the Term Stacking Algorithm. For simplicity, suppose a case either takes 1, 2, 3, 4, 5 years and consider K = 3 dynamic terms:

$$F \left(A , T , B\right) = \left\{\begin{matrix}min \left(A , 5 {m}_{1} + {f}_{1} A\right) \\ min \left(A , 5 {m}_{2} + {f}_{2} A\right) \\ min \left(A , 5 {m}_{3} + {f}_{3} A\right)\end{matrix} \begin{matrix}\text{if} T = 1 \text{year} \\ \text{if} T = 2 \text{years} \\ \text{if} T \geq 3 \text{years}\end{matrix}\right)$$

FIG. 2(h) illustrates the main steps in an application of the Term Stacking approach for this example. In Step 1, the Term Stacking algorithm generates different multiple and percentage combinations for each duration and filters out terms that violate local constraints LC1-LC3. Since LC3 is a Pareto optimality constraint, the remaining terms are local Pareto optimal. Step 2 generates each Pareto curve based on the filtered terms from Step 1. A user then specifies a point (i.e., each star in FIG. 2(h)) on each Pareto curve, and the Term Stacking algorithm returns the terms associated with those points. Finally, each selected term for a particular duration range is “stacked” together to generate the full funding term. If this stacked term satisfies GC1-GC2, the term is added to the “Funder Term Zone”. Otherwise, Steps 2 and 3 are repeated until GC1-GC2 are satisfied.

Step 2 requires manual user specification to build the “Funder Term Zone.” The full Term Stacking algorithm automates Step 2 using techniques from multi-objective optimization (e.g., linear scalarization method or the epsilon-constraint method) so that no manual input is required.

### Valuing Terms Over Time and Increasing Information

In the above descriptions, the disclosure showed how to value and construct a F at time t = 0. Next, an approach for valuing F at an arbitrary time is described by making a small generalization to the previous framework. Before discussing this extension, it is helpful to discuss why value changes over time.

The value of F may change over time due to the duration-dependent nature of funding terms, and/or new information. In treaty arbitration, for example, proceedings are sometimes bifurcated. When cases have bifurcated proceedings, the Tribunal will issue incremental, binary decisions in stages, the first of which is to decide whether or not a Tribunal has the jurisdiction to decide the case at hand. If the jurisdiction decision is negative, then the Claimant’s case will not advance to the next stage for consideration of merits and damages. If the jurisdiction decision is positive, then the claimants will proceed to the next stages. The value of F will adjust in light of this information.

Specifically, F will be valued 0 if the jurisdiction decision is negative. And F will increase in value if the jurisdiction decision is positive compared to when the jurisdiction decision was unknown, because one potential path to loss has now been eliminated. Even if no new information about the case is known relative to time t = 0, the value of the case can change since the remaining duration of the case decreases and the terms themselves are potentially duration-dependent.

### Dynamic Valuation of F

It is desirable to compute the value of F at time t when more information is observed or otherwise becomes known about a case. To this end, define the resell net present value (RNPV) of the term (i.e., how much an investor should pay for F at time t > 0) as Equation 4 below:

$$E \left[R N P V \left({r}_{min} , F\right) \left|{I}_{t}\right)\right] = E \left[{\sum }_{t ′ = t}^{T} {C}_{t} {\left(1 + {r}_{min}\right)}^{- t ′} \left|{I}_{t}\right)\right] ,$$

Where Iₜ denotes information known about a case at time t. Notice that the cash flow distribution(s) expressed in Equation 4 are drawn conditional on Iₜ. Returning to example from before, if jurisdiction is accepted, then P(0 = win | Iₜ) is higher than P(0 = win | I₀), which was the distribution used to initially price F. In general, since a probabilistic approach is used, the distributions on award size, duration, and cost are coherently updated with new information, leading to coherent changes in valuations via Equation 4.

Notice also that Equation 4 ignores cash outflows prior to time t (e.g., initial committed capital and management fees). For a funder who invested at time 0, the net time-adjusted return (or loss) at time t equals

$$E \left[R N P V \left({r}_{min} , F\right) \left|{I}_{t}\right)\right] + \left[- B {\left(1 + {r}_{min}\right)}^{t} + {\sum }_{0 < t ′ < t} {C}_{t} {\left(1 + {r}_{min}\right)}^{t - t ′}\right]$$

### Valuation of Fractional Funding Terms

Instead of selling an entire funding term, a funder might only want to sell a portion of her investment. To this end, suppose a funder slices her term F into M fractional terms F₁, ..., F_{M} so that F =

$$\sum {}_{m = 1}^{M}$$

Fₘ. For example, if F equals 3 × cost plus 20% of the award, F₁ could equal the 3 × cost provision and F₂ could equal the 20% provision. The following proposition says that expected net present value of a funding term equals the sum of expected net present of the fractional terms. Hence, the value of a term cannot be artificially increased or decreased by breaking up a term into smaller parts using the valuation methodology expressed in Equation 4. Suppose F =

$$\sum {}_{m = 1}^{M}$$

Fₘ. Then,

$$E \left[R N P V \left({r}_{min} , F\right) \left|{I}_{t}\right)\right] = {\sum }_{m = 1}^{M} E \left[R N P V \left({r}_{min} , F\right) \left|{I}_{t}\right)\right] .$$

FIG. 2 is a diagram illustrating elements or components that may be present in a computing device, server, or system 200 configured to implement a method, process, function, or operation in accordance with an embodiment of the system and methods disclosed herein. As noted, in some embodiments, the system and methods may be implemented in the form of an apparatus that includes a processing element and set of executable instructions. The executable instructions may be stored in a memory or data storage element and be part of a software application and arranged into a software architecture.

In general, an embodiment may be implemented using a set of software instructions that are designed to be executed by a suitably programmed processing element (such as a GPU, CPU, TPU, QPU, state machine, microprocessor, processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed system and methods.

The application modules and/or sub-modules may include any suitable computer-executable code or set of instructions (e.g., as would be executed by a suitably programmed processor, co-processor, microprocessor, or CPU, as non-limiting examples), such as computer-executable code corresponding to a programming language. For example, programming language source code may be compiled into computer-executable code. Alternatively, or in addition, the programming language may be an interpreted programming language such as a scripting language.

Modules 202 shown in FIG. 2 may contain one or more sets of instructions for performing a method or function described with reference to the Figures, and the disclosure of the functions and operations provided in the specification. These modules may include those illustrated but may also include a greater number or fewer number than those illustrated.

As mentioned, each module may contain a set of computer-executable instructions. The set of instructions may be executed by a programmed processor or co-processor contained in a server, client device, network element, system, platform, or other component. The computer-executable instructions that are contained in the modules or in a specific module may be executed by the same processor or by different processors. Further, the computer-executable instructions that are contained in a single module may be executed (in whole or in part) by one processor (or co-processor) or by more than one processor (or co-processor).

A module (or sub-module) may contain instructions that are executed by a processor (or co-processor) contained in more than one of a server, client device, network element, system, platform or other component. Thus, in some embodiments, a plurality of electronic processors, with each being part of a separate device, server, or system may be responsible for executing all or a portion of the software instructions contained in an illustrated module. Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing device. Modules 202 each contain a set of executable instructions, where when the set of instructions is executed by a suitable electronic processor (such as that indicated in the figure by “Physical Processor(s) 230”), system (or server or device) 200 operates to perform a specific process, operation, function, or method. Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules and the set of computer-executable instructions that are contained in the modules may be executed by the same processor or by more than a single processor.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of an electrical “bus” or communications line 219, which also serves to permit processor(s) 230 to communicate with the modules for purposes of accessing and executing a set of instructions. Bus or communications line 219 also permits processor(s) 230 to interact with other elements of system 200, such as input or output devices 222, communications elements 224 for exchanging data and information with devices external to system 200, and additional memory devices 226.

Each application module or sub-module may correspond to a specific function, method, process, or operation that is implemented by the module or sub-module. Each module or sub-module may contain a set of computer-executable instructions that when executed by a programmed processor or processors cause the processor or processors (or a device or devices in which they are contained) to perform the specific function, method, process, or operation. Such function, method, process, or operation may include those used to implement one or more aspects of the disclosed system and methods, such as for:
Determine a Set Of Cash Flows For a Term That Is Part of a Transaction (as suggested by module 206);
For Each Possible Cash Flow for the Term, Determine the Net Present Value (module 208);
For Each Possible Cash Flow for the Term, Determine Probability of Occurrence (module 210);
Determine Expected Net Present Value of Term of Transaction Resulting in Each Cash Flow of the Set of Cash Flows (the Probability of Occurrence Weighted Average Over Net Present Values, module 212);
Determine Optimal Parameter/Terms Based on Multiple Objectives and/or Constraints (module 214); and
Dynamically Revalue Parameters/Terms OverTime Based on Events Occurring During Agreement (module 216).

As mentioned, each module may contain instructions which when executed by a programmed processor cause an apparatus (such as a server or client device) to perform the specific function or functions. The apparatus may be one or both of a client device or a remote server or platform. Therefore, a module may contain instructions that are performed by the client device, the server or platform, or both.

Although one or more embodiments of the disclosure have been described in detail, the disclosure includes other possible implementations and use cases, non-limiting examples of which are described in the following. As shown in FIG. 1(b), in some embodiments, there are 5 general inputs or factors considered by the Term Construction Engine:
Valuation Model;
Funding Space;
Funding Objectives;
Funding Constraints; and
Optimization Routine.

In one or more of the examples described herein, the inventors selected specific choices or relationships for these 5 inputs. However, the general methodology disclosed is also applicable to other choices of inputs, as illustrated in the following non-limiting examples, which are not intended to be an exhaustive list or description of the possible ways of using or implementing the approach and methodology described herein.

### Example Extensions of the Valuation Model

In one or more of the embodiments, the valuation of a term is based on the expected net present value (ENPV) of the term, which equals the expected value of all current and future discounted cash flows. However, ENPV is only one possible way to summarize the cash flow distribution associated with a funding term.

For example, one might instead look at ENPV/Variance (term) to normalize ENPV for the spread of a term. Such a normalization by spread is analogous to the Sharpe Ratio used in finance. As another example (and similar to the Sortino Ratio), would be to look at ENPV/Var(term | NPV < 0), where Var(term NPV) is the variance of cash flows conditional on the NPV being negative (i.e., a measure of downside risk).

The probabilistic approach towards valuation disclosed herein generalizes single scenario valuation approaches (e.g., discounted cash flows); in the single scenario setting, one makes the cash flow probability distribution equal to a particular cash flow sequence with a probability of one.

### Example Extensions of the Funding Space

Embodiments typically considered a space of terms that vary as a function of duration. However, there are other choices of funding terms and their dependencies. Such modifications may be used to account for case-specific nuances. For example, a case might have already received funding from another funder, where the funding agreement states that all future funders must be less senior in the waterfall. In this instance, the funding space would need to be modified to account for a less senior position in the waterfall.

As another example, one might make funding terms vary as a function of cost (e.g., if less than $5M is spent, then the terms are A and if more than $5M is spent, then the terms are B). Terms could also depend on different financing options. For example, terms might depend on the amount of equity and debt used to pay for fees, or the use of insurance to protect against adverse events (e.g., by the inclusion or absence of “after the event insurance” in the funding term).

An approach to construct new types of terms is to increase the dimension of the funding space. For example, suppose one wanted to construct terms that vary as a function of duration (yearly up to 5 years) and cost (less than $5M or more than $5M spent). Then, the space of funding terms is isomorphic to a 20-dimensional space (for each year and cost bucket, there is a multiple on cost and fractional stake in the award parameters. Since there are 10 combinations of year and cost buckets, there are 20 total parameters).

### Example Extensions of the Funding Objectives

In some embodiments, the approach considered the ENPV and expected Claimant share of the award as the two funding objectives. In general, one can use an arbitrary number of funding objectives, and the objectives can be an arbitrary summary of the cash flow distribution (as described in the section “Example Extensions of the Valuation Model”).

### Example Extensions of the Funding Constraints

In some embodiments, two types of constraints were considered: global constraints (which hold in overall expectation) and local constraints (which hold conditional on a particular event). However, there are other types of constraints that may be used. For example, instead of expected value constraints, one could consider probability constraints (e.g., require with a probability of 95% that the Claimant will retain the majority of the award in the event of a positive award). For local constraints, embodiments considered minimum thresholds for expected NPV and expected Claimant share conditional on particular duration ranges. To construct terms that are robust to other uncertainties beyond duration, a similar approach may be used. For example, to protect against under or over budgeting, one could require that the expected NPV exceed some threshold conditional on under or over budgeting.

### Example Extensions of the Optimization Routine

In some embodiments, the Term Stacking Algorithm was used to identify optimal terms that meet the Funding Constraints. This algorithm depended on some of the specific choices for the inputs. When the inputs change (e.g., as described in the examples above), other types of optimization techniques may be preferable to use. In this regard, there are several general-purpose optimization solvers that could be used. Examples of such general-purpose solvers include gradient methods (e.g., stochastic gradient descent, Newton’s method), evolutionary algorithms (e.g., simulated annealing, CMA-ES), multi-objective optimization techniques (e.g., weighted-sum, epsilon-constraint, weighted metric, Kung’s method), Bayesian optimization, and Quasi-Newton methods (e.g., BFGS, Broyden, or DFP).

The following provides additional information on a procedure or approach that may be used to generate the cash flows disclosed as part of one or more embodiments. Valuing a term often requires specifying a distribution on cash flows (e.g., when using ENPV to reach a valuation). The following describes how to generate a distribution on cash flows in a setting beyond that of litigation finance. The approach to generating cash flows and constructing the space of terms in a general setting or application enables the disclosed methodology to be applied more generally based on (1) computing the ENPV (via Monte Carlo) once a distribution on cash flows is specified, and (2) allows selection of the terms once a space of funding terms is defined.

A general construction is as follows:
Step 1: Enumerate all uncertain events (i.e., random variables) for a situation or investment of interest that impacts returns and/or the valuation of a funding term. Denote the set of all such M random events as E₁,...,E_{M}, where M is an integer. In one or more of the disclosed embodiments, as an example, M=4 and E₁= cost, E₂ = duration, E₃= award size, and E₄ = case outcome;
Step 2: Specify a joint distribution on (E₁,...,E_{M}) using one or more of machine learning, statistical methods, and/or subject matter expert inputs; and
Step 3: Generate cash flows conditional on (E₁,...,E_{M}). Since as constructed, (E₁,...,E_{M}) accounts for all uncertainties relevant to the situation of interest, the cash flows are a deterministic function of (E_{1.}...,E_{M}). Hence, a joint distribution on E₁,...,E_{M}) automatically produces a distribution on cash flows.

Step 3 represents that to generate a distribution on cash flows, it suffices to (1) specify a joint distribution on (E₁,...,E_{M}), and (2) specify the functional relationship between (E₁,...,E_{M}) and cash flows. This is further demonstrated by the illustrative examples that follow.

### Generation of Space of Terms

To select optimal terms, the approach constructs a space of possible funding terms to perform the optimization process. The following describes how to construct a space of terms in a general setting.
Step 1: Enumerate one or more possible modifications to a funding term for a situation or investment of interest (e.g., the inclusion or exclusion of a certain provision in the funding agreement, the payout structure, etc.);
Step 2: For each of the j possible modifications of a term, associate a real-valued parameter ɵⱼ for the j^{th} possible modification of the term for 1 < j <J.

Using this construction, the space of terms is isomorphic to a J-dimensional subspace of R^{j}. In a previous example, the approach considered a situation where the multiple-on-cost and percentage in the award could vary as a function of duration (for up to 5 years). In that example, J=10 (for each year there is a parameter for the multiple-on-cost and a parameter for the percentage of award).

The examples below are for illustration purposes only (i.e., they are not intended to be an exhaustive list or description of the possible ways of using or implementing the approach and methodology described herein):
Litigation Finance Example. The graph of FIG. 2(b) illustrates one way of generating cash flows (from the perspective of the limited partners of a litigation fund). Here E₁ = cost, E₂ = duration, E3= award size, and B = committed capital. F(E3 E2 B; ɵ) represents a dynamic funding term, where ɵ consists of all multiple-on-cost and percentage parameters which uniquely define the funding term.

As shown in the figure, the cash flows are a deterministic function of B, E₁, E₂, and E₃. The red labels represent cash outflows, and the green label represents cash inflows. For example, at time t=0, there is a cash outflow of committed capital and management fees. During each period, management fees are drawn until the case terminates at time E₂. At time E2 the limited partners receive the payout determined by the term and unused budget minus fees (management fees and carried interest).
After the Insurance Example. The graph of FIG. 2(c) illustrates one way of generating cash flows (from the perspective of the insurer) in an insurance context. Here, E₁ represents the amount in damages if the adverse event occurs, E2 represents the time at which the adverse event occurs (if the event never occurs, we may assume E₂ = ∞ without loss of generality). In this example, the policy depends on two parameters: ɵ₁, the lifetime of the insurance policy and ɵ₂, the maximum coverage amount;
Biotech Investing Example. In early-stage drug development, a biotech company needs to obtain regulatory approval from the FDA before selling the drug. The graph of FIG. 2(d) summarizes one way to generate cash flows for this situation.

In this example, it is assumed that the company must pass four phases of clinical trials before obtaining approval. To this end, let Bi represent the cost for the i^{th} clinical trial for 1 < i < 4. A later clinical trial will only occur if the previous clinical was successful. Hence, one can let E2, E4 , and E6 equal binary random variables indicating if the first, second, and third clinical trials were successful. Let E₁, E₃, and E₅ denote the times at which the second, third, and fourth clinical trials start. E₇ represents the time at which the fourth clinical trial concludes and when the drug can be sold on the market (if approved). E₈ represents the yearly revenue of the drug (if the drug is not approved, then E₈ = 0). F represents the funding term which depends on the funding parameters ɵ. ɵ may consist of parameters indicating what percent of revenues the funder receives (which may decrease over time or once the funder has recouped her capital) and the presence of royalties.

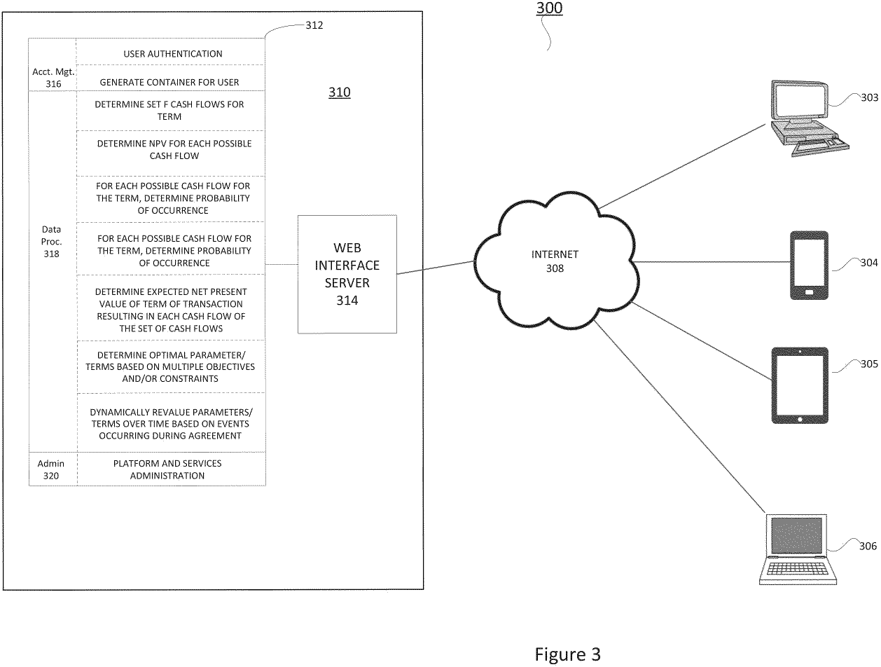

In some embodiments, the systems and methods described herein may provide services through a Software-as-a-Service (SaaS) platform or multi-tenant platform. The platform provides access to multiple entities, each with a separate account and associated data storage. Each account may correspond to a request for valuation of a term, or a set of terms that need valuation as part of a negotiation or decision process, for example. Each account may access one or more services, a set of which are instantiated in their account, and which implement one or more of the methods or functions described herein. FIGS. 3-5 are diagrams illustrating a deployment of the system and methods described herein as a service or application provided through a Software-as-a-Service platform, in accordance with some embodiments.

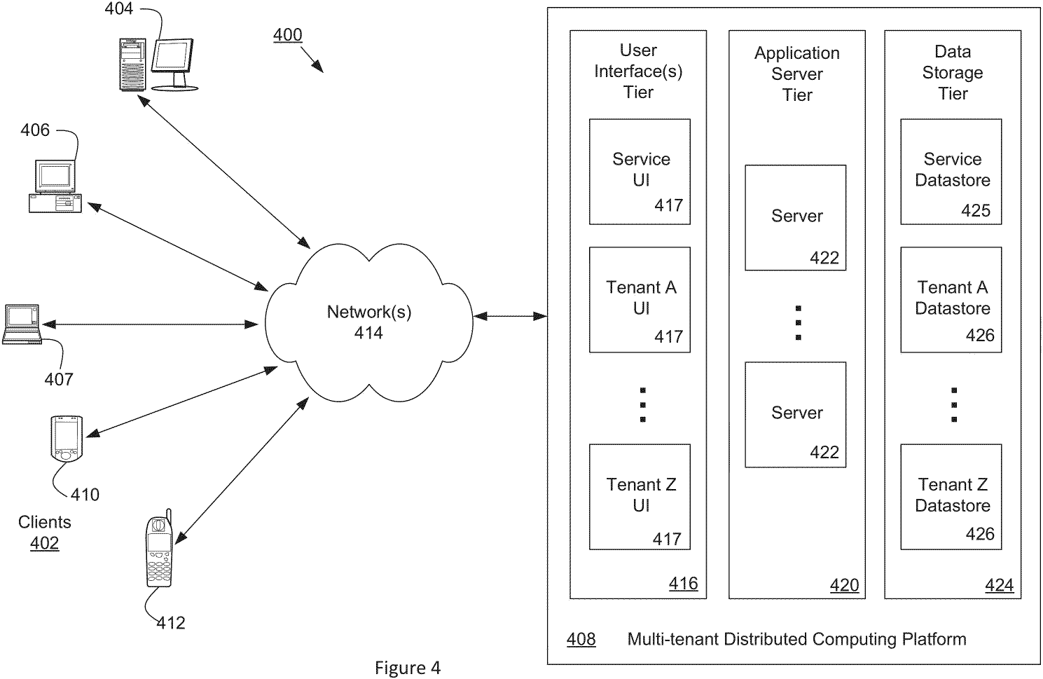

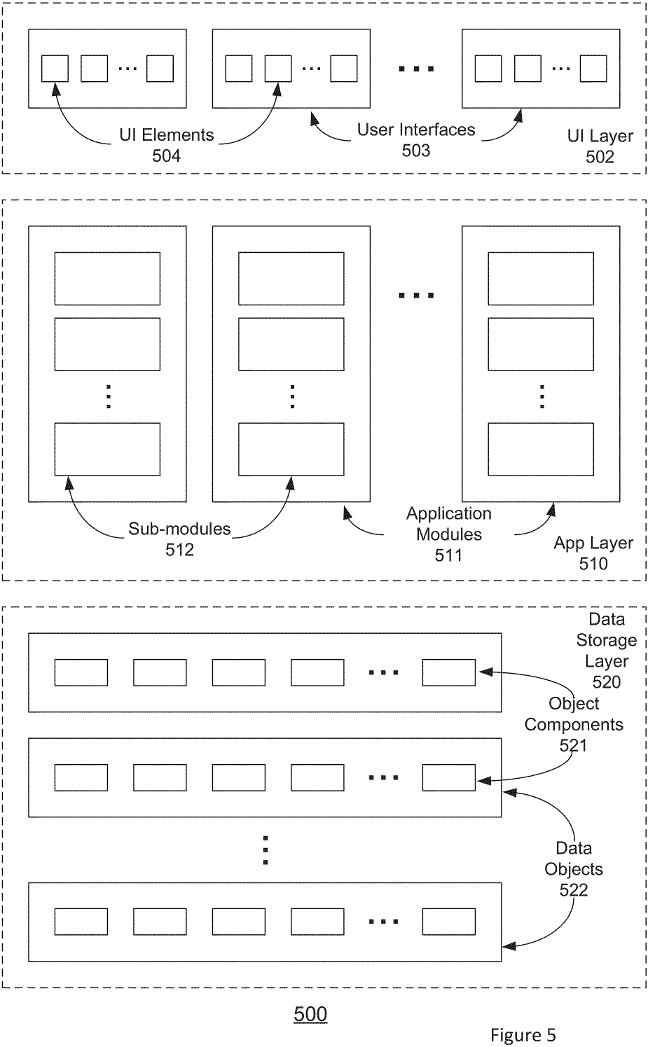

FIGS. 3-5 are diagrams illustrating an architecture for a multi-tenant or SaaS platform that may be used in implementing an embodiment of the systems and methods described herein. In some embodiments, the functionality and services provided by the system and methods described herein may be made available to multiple users by accessing an account maintained by a server or service platform. Such a server or service platform may be termed a form of Software-as-a-Service (SaaS). FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) described herein may be implemented as micro-services, processes, workflows, or functions performed in response to a user request. The micro-services, processes, workflows, or functions may be performed by a server, data processing element, platform, or system. In some embodiments, the services may be provided by a service platform located “in the cloud”. In such embodiments, the platform is accessible through APIs and SDKs. The described data processing and services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the data processing methodology described herein. Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform. For example, some of the functions and services described with reference to FIGS. 3-5 may be provided by a 3^{rd} party with the provider of the trained models maintaining an account on the platform for each company or business using a trained model to provide services to that company’s customers.

FIG. 3 is a diagram illustrating a system 300 in which an embodiment of the invention may be implemented or through which an embodiment of the services described herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, etc. In general, any client device having access to the Internet may be used to provide a request or text message requesting customer support services and to receive and display an intent tree model. Users interface with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both services 312 and the web interface server 314 may be implemented on one or more different hardware systems and components, even though represented as singular units in FIG. 3. Services 312 may include one or more functions or operations for the determination of an optimal term or terms for an agreement as described herein.

In some embodiments, the set of services or applications available to a company or user may include one or more that perform the functions and methods described herein with reference to the enclosed figures. As examples, in some embodiments, the set of applications, functions, operations or services made available through the platform or system 310 may include:
account management services 316, such as
   a process or service to authenticate a person wishing to access the services/applications available through the platform (such as credentials or proof of purchase, verification that the customer has been authorized by a company to use the services, etc.);
   a process or service to generate a container or instantiation of the services, methodology, applications, functions, and operations described, where the instantiation may be customized for a particular user or company; and
   other forms of account management services.;
a set 318 of data processing services, applications, functionality, etc., such as a process or service for one or more of:
   Determine a Set Of Cash Flows For a Term That Is Part of a Transaction;
   For Each Possible Cash Flow for the Term, Determine the Net Present Value (NPV);
   For Each Possible Cash Flow for the Term, Determine Probability of Occurrence;
   Determine Expected Net Present Value of Term of Transaction Resulting in Each Cash Flow of the Set of Cash Flows (the Probability of Occurrence Weighted Average Over Net Present Values);
   Determine Optimal Parameter/Terms Based on Multiple Objectives and/or Constraints; and
   Dynamically Revalue Parameters/Terms OverTime Based on Events Occurring During Agreement;
administrative services 320, such as
   a process or services to enable the provider of the data processing services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment of the invention may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, ..., “Tenant Z UI” in the figure, and which may be accessed via one or more APIs).

The default user interface may include user interface components enabling a tenant to administer the tenant’s access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions.

The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform’s Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business’ data processing workflow (such as the data processing and term description processes disclosed herein) are provided to users, with each company/business representing a tenant of the platform. One advantage to such multi-tenant platforms is the ability for each tenant to customize their instantiation of the data processing workflow to that tenant’s specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment of the disclosure may be implemented. The software architecture shown in FIG. 5 represents an example of an architecture which may be used to implement an embodiment of the disclosure. In general, an embodiment may be implemented using a set of software instructions that are designed to be executed by a suitably programmed processing element (such as a CPU, microprocessor, processor, co-processor, or controller, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the disclosure may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing business related data processing and services to a user of the platform). Such function, method, process, or operation may include those used to implement one or more aspects of the disclosed system and methods, such as for one or more of the processes, services, or functions disclosed herein and/or described with reference to the Figures:
Determine a Set Of Cash Flows For a Term That Is Part of a Transaction;
For Each Possible Cash Flow for the Term, Determine the Net Present Value (NPV);
For Each Possible Cash Flow for the Term, Determine Probability of Occurrence;
Determine Expected Net Present Value of Term of Transaction Resulting in Each Cash Flow of the Set of Cash Flows (the Probability of Occurrence Weighted Average Over Net Present Values);
Determine Optimal Parameter/Terms Based on Multiple Objectives and/or Constraints; and
Dynamically Revalue Parameters/Terms Over Time Based on Events Occurring During Agreement.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 420 may include one or more data objects 422 each having one or more data object components 421, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:
1. A method of automatically constructing and valuing a term in a litigation funding agreement for a case, comprising:
   determining one or more sets of cash flows for a term by expressing each cash flow as a function of the term and a set of known and unknown case events;
   for each of the set of cash flows for the term
      determining a net present value (NPV) of the cash flow;
      determining a probability of occurrence of the cash flow by constructing a probability distribution for the unknown case events; and
      determining a probability of occurrence weighted average over the net present value of the cash flow to produce an expected value for the term;
   determining an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
   dynamically revaluing the term over time based on case events occurring during the agreement.
2. The method of clause 1, wherein determining the probability of occurrence of the cash flow is performed using a Monte Carlo simulation.
3. The method of clause 1, wherein the case events occurring during the agreement comprise one or more of a decision regarding a motion, information found during a discovery process, or information regarding a status of a dispute that is part of the case.
4. The method of clause 1, wherein the expected value for the term is generated using a trained model for one or more case events, wherein the case events include a case outcome, a case award, a case duration, and a case cost, and a predicted value of one or more of the case events is used as part of determining the set of cash flows for the term.
5. The method of clause 4, further comprising generating the predicted the value for one or more of the case events based on one or more of an expert input and a detail of the case.
6. The method of clause 1, wherein each set of cash flows for the term represent income expected to be generated by the term over time.
7. The method of clause 1, wherein the combinations of an allocation of an award and multiples of committed capital in the case for each of a plurality of durations of the funding agreement are used to generate a grid, and a search process evaluates the combinations that satisfy one or more funding constraints.
8. A system for constructing and valuing a term in a litigation funding agreement for a case, comprising:
   one or more non-transitory computer-readable media including a set of computer-executable instructions;
   one or more electronic processors configured to execute the set of computer-executable instructions, wherein when executed, the instructions cause the one or more electronic processors or an apparatus containing the electronic processors to
      determine one or more sets of cash flows for a term by expressing each cash flow as a function of the term and a set of known and unknown case events;
      for each of the set of cash flows for the term
         determine a net present value (NPV) of the cash flow;
         determine a probability of occurrence of the cash flow by constructing a probability distribution for the unknown case events; and
         determine a probability of occurrence weighted average over the net present value of the cash flow to produce an expected value for the term;
      determine an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
      dynamically revalue the term over time based on case events occurring during the agreement.
9. The system of clause 8, wherein determining the probability of occurrence of the cash flow is performed using a Monte Carlo simulation.
10. The system of clause 8, wherein the case events occurring during the agreement comprise one or more of a decision regarding a motion, information found during a discovery process, or information regarding a status of a dispute that is part of the case.
11. The system of clause 8, wherein the expected value for the term is generated using a trained model for one or more case events, wherein the case events include a case outcome, a case award, a case duration, and a case cost, and a predicted value of one or more of the case events is used as part of determining the set of cash flows for the term.
12. The system of clause 11, further comprising generating the predicted the value for one or more of the case events based on one or more of an expert input and a detail of the case.
13. The system of clause 8, wherein each set of cash flows for the term represent income expected to be generated by the term over time.
14. The system of clause 8, wherein the combinations of an allocation of an award and multiples of committed capital in the case for each of a plurality of durations of the funding agreement are used to generate a grid, and a search process evaluates the combinations that satisfy one or more funding constraints.
15. One or more non-transitory computer-readable media including a set of computer-executable instructions that when executed by one or more programmed electronic processors, cause the processors or an apparatus containing the electronic processors to
   determine one or more sets of cash flows for a term by expressing each cash flow as a function of the term and a set of known and unknown case events;
   for each of the set of cash flows for the term
      determine a net present value (NPV) of the cash flow;
      determine a probability of occurrence of the cash flow by constructing a probability distribution for the unknown case events; and
      determine a probability of occurrence weighted average over the net present value of the cash flow to produce an expected value for the term;
   determine an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
   dynamically revalue the term over time based on case events occurring during the agreement.
16. The one or more non-transitory computer-readable media of clause 15, wherein determining the probability of occurrence of the cash flow is performed using a Monte Carlo simulation.
17. The one or more non-transitory computer-readable media of clause 15, wherein the case events occurring during the agreement comprise one or more of a decision regarding a motion, information found during a discovery process, or information regarding a status of a dispute that is part of the case.
18. The one or more non-transitory computer-readable media of clause 15, wherein the expected value for the term is generated using a trained model for one or more case events, wherein the case events include a case outcome, a case award, a case duration, and a case cost, and a predicted value of one or more of the case events is used as part of determining the set of cash flows for the term.
19. The one or more non-transitory computer-readable media of clause 15, wherein each set of cash flows for the term represent income expected to be generated by the term over time.
20. The one or more non-transitory computer-readable media of clause 15, wherein the combinations of an allocation of an award and multiples of committed capital in the case for each of a plurality of durations of the funding agreement are used to generate a grid, and a search process evaluates the combinations that satisfy one or more funding constraints

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as openended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. A method of automatically constructing and valuing a term in a litigation funding agreement for a case, comprising:
determining one or more sets of cash flows for a term by expressing each cash flow as a function of the term and a set of known and unknown case events;
for each of the set of cash flows for the term
determining a net present value (NPV) of the cash flow;
determining a probability of occurrence of the cash flow by constructing a probability distribution for the unknown case events; and
determining a probability of occurrence weighted average over the net present value of the cash flow to produce an expected value for the term;
determining an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
dynamically revaluing the term over time based on case events occurring during the agreement.

2. The method of claim 1, wherein determining the probability of occurrence of the cash flow is performed using a Monte Carlo simulation.

3. The method of claim 1, wherein the case events occurring during the agreement comprise one or more of a decision regarding a motion, information found during a discovery process, or information regarding a status of a dispute that is part of the case.

4. The method of claim 1, wherein the expected value for the term is generated using a trained model for one or more case events, wherein the case events include a case outcome, a case award, a case duration, and a case cost, and a predicted value of one or more of the case events is used as part of determining the set of cash flows for the term.

5. The method of claim 4, further comprising generating the predicted the value for one or more of the case events based on one or more of an expert input and a detail of the case.

6. The method of claim 1, wherein each set of cash flows for the term represent income expected to be generated by the term over time.

7. The method of claim 1, wherein the combinations of an allocation of an award and multiples of committed capital in the case for each of a plurality of durations of the funding agreement are used to generate a grid, and a search process evaluates the combinations that satisfy one or more funding constraints.

8. A system for constructing and valuing a term in a litigation funding agreement for a case, comprising:
one or more non-transitory computer-readable media including a set of computer-executable instructions;
one or more electronic processors configured to execute the set of computer-executable instructions, wherein when executed, the instructions cause the one or more electronic processors or an apparatus containing the electronic processors to
determine one or more sets of cash flows for a term by expressing each cash flow as a function of the term and a set of known and unknown case events;
for each of the set of cash flows for the term
determine a net present value (NPV) of the cash flow;
determine a probability of occurrence of the cash flow by constructing a probability distribution for the unknown case events; and
determine a probability of occurrence weighted average over the net present value of the cash flow to produce an expected value for the term;
determine an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
dynamically revalue the term over time based on case events occurring during the agreement.

9. The system of claim 8, wherein determining the probability of occurrence of the cash flow is performed using a Monte Carlo simulation.

10. The system of claim 8, wherein the case events occurring during the agreement comprise one or more of a decision regarding a motion, information found during a discovery process, or information regarding a status of a dispute that is part of the case.

11. The system of claim 8, wherein the expected value for the term is generated using a trained model for one or more case events, wherein the case events include a case outcome, a case award, a case duration, and a case cost, and a predicted value of one or more of the case events is used as part of determining the set of cash flows for the term.

12. The system of claim 11, further comprising generating the predicted the value for one or more of the case events based on one or more of an expert input and a detail of the case.

13. The system of claim 8, wherein each set of cash flows for the term represent income expected to be generated by the term over time.

14. The system of claim 8, wherein the combinations of an allocation of an award and multiples of committed capital in the case for each of a plurality of durations of the funding agreement are used to generate a grid, and a search process evaluates the combinations that satisfy one or more funding constraints.

15. One or more non-transitory computer-readable media including a set of computer-executable instructions that when executed by one or more programmed electronic processors, cause the processors or an apparatus containing the electronic processors to
determine one or more sets of cash flows for a term by expressing each cash flow as a function of the term and a set of known and unknown case events;
for each of the set of cash flows for the term
determine a net present value (NPV) of the cash flow;
determine a probability of occurrence of the cash flow by constructing a probability distribution for the unknown case events; and
determine a probability of occurrence weighted average over the net present value of the cash flow to produce an expected value for the term;
determine an optimal configuration for the term by maximizing one or more funding objectives subject to one or more funding constraints over a defined funding space, wherein the defined funding space includes multiple combinations of an allocation of an award and multiples of committed capital in the case for each of a plurality of durations of the funding agreement; and
dynamically revalue the term over time based on case events occurring during the agreement.

16. The one or more non-transitory computer-readable media of claim 15, wherein determining the probability of occurrence of the cash flow is performed using a Monte Carlo simulation.

17. The one or more non-transitory computer-readable media of claim 15, wherein the case events occurring during the agreement comprise one or more of a decision regarding a motion, information found during a discovery process, or information regarding a status of a dispute that is part of the case.

18. The one or more non-transitory computer-readable media of claim 15, wherein the expected value for the term is generated using a trained model for one or more case events, wherein the case events include a case outcome, a case award, a case duration, and a case cost, and a predicted value of one or more of the case events is used as part of determining the set of cash flows for the term.

19. The one or more non-transitory computer-readable media of claim 15, wherein each set of cash flows for the term represent income expected to be generated by the term over time.

20. The one or more non-transitory computer-readable media of claim 15, wherein the combinations of an allocation of an award and multiples of committed capital in the case for each of a plurality of durations of the funding agreement are used to generate a grid, and a search process evaluates the combinations that satisfy one or more funding constraints.
